(19) United States
(12) Patent Application Publication
(10) Pub. No.: US 2024/0356352 A1
(43) Pub. Date: Oct. 24, 2024

(54) CHARGING DOCK DEVICE

(71) Applicant: Hand Held Products, Inc., Charlotte, NC (US)

(72) Inventors: Hang TIAN, Charlotte, NC (US); Xiaojin HAN, Charlotte, NC (US); Yihua NIU, Charlotte, NC (US)

(21) Appl. No.: 18/617,000

(22) Filed: Mar. 26, 2024

(30) Foreign Application Priority Data
Apr. 20, 2023 (CN) 202320904852.8

(51) Int. Cl. H02J 7/00

(52) U.S. Cl. CPC H02J 7/0044

(57) ABSTRACT

In some embodiments, a charging dock device includes a housing configured to receive one or more user devices. In some embodiments, the charging dock device is configured to charge the one or more user devices when the one or more user devices are disposed on or within the housing of the charging dock device; and one or more rotation plates disposed on or within the housing, wherein the one or more rotation plates are configured to rotate between a first position and a second position, wherein when the rotation plates are in the first position the housing is configured to receive a first user device of the one or more user devices, and the housing is configured to receive a second user device of the one or more user devices when the rotation plates are in the second position.

### CROSS-REFERENCE TO RELATED APPLICATIONS

This application claims priority pursuant to 35 U.S.C. 119 (a) to Chinese Application No. 202320904852.8, filed Apr. 20, 2023, which application is incorporated herein by reference in its entirety.

### TECHNICAL FIELD

The present disclosure relates generally to charging devices. In particular, it relates to charging docks for user devices having varying shapes, sizes, and orientations.

### BACKGROUND

Charging docks may be simple, efficient, and ergonomic devices for charging various user devices (e.g., mobile devices or tablet computers). User devices may vary in shape, size, and orientation, though, requiring different charging devices to accommodate different designs. Further, user devices may change in size and shape when a user puts a protective sleeve over the device, and different charging docks may be required to accommodate user devices encased in protective sleeves compared to those not encased in protective sleeves.

Through applied effort, ingenuity, and innovation, Applicant has solved problems relating to charging docks by developing solutions embodied in the present disclosure, which are described in detail below.

### SUMMARY

In general, embodiments of the present disclosure provide charging dock devices, methods, and/or the like.

According to various embodiments there is provided a charging dock device including: a housing configured to receive one or more user devices, wherein the charging dock device is configured to charge the one or more user devices when the one or more user devices are disposed on or within the housing of the charging dock device; and one or more rotation plates disposed on or within the housing, wherein the one or more rotation plates are configured to rotate between a first position within the housing and a second position within the housing, wherein when the rotation plates are in the first position the housing is configured to receive a first user device of the one or more user devices, and wherein when the rotation plates are in the second position the housing is configured to receive a second user device of the one or more user devices.

In some embodiments, the first user device of the one or more user devices is smaller than the second user device of the one or more user devices.

In some embodiments, the second user device of the one or more user devices is at least partially encased in a sleeve.

In some embodiments, the charging dock device further includes a base, wherein the housing is fixedly attached to the base.

In some embodiments, the one or more rotation plates includes a guiding rib, the housing includes a groove, and the guiding rib is configured to operably engage with the groove.

In some embodiments, the one or more rotation plates further includes a shaft, the housing further includes a shaft hole, and the shaft is configured to be inserted into the shaft hole.

In some embodiments, the one or more rotation plates further includes a positioning pin, the housing includes one or more positioning holes, and the positioning pin is configured to be inserted into and toggled between the one or more positioning holes.

In some embodiments, the one or more rotation plates further includes a rear wall configured to at least partially support the one or more user devices.

In some embodiments, the housing includes a first end and a second end, wherein the one or more rotation plates includes a first rotation plate and a second rotation plate, and wherein the first rotation plate is disposed on or within the first end and the second rotation plate is disposed one or within the second end.

According to various embodiments, there is provided a method of using a charging dock device, the method including inserting one or more rotation plates into a housing of a charging dock device; rotating, by a positioning pin, the one or more rotation plates within the housing of the charging dock device from a first position to a second position, wherein when the one or more rotation plates are in the first position the housing is configured to receive a first user device; and rotating, by the positioning pin, the one or more rotation plates within the housing of the charging dock device from the second position to the first position, wherein when the one or more rotation plates are in the second position the housing is configured to receive a second user device.

In some embodiments, the method further includes inserting the first or the second user device into the housing of the charging dock device.

In some embodiments, the method further includes charging, by the charging dock device, the first or second user device.

In some embodiments, the first user device is smaller than the second user device.

In some embodiments, the second user device of the one or more user devices is at least partially encased in a sleeve.

The above summary is provided merely for purposes of summarizing some example embodiments to provide a basic understanding of some embodiments of the disclosure. Accordingly, it will be appreciated that the above-described embodiments are merely examples. It will be appreciated that the scope of the disclosure encompasses many potential embodiments in addition to those here summarized, some of which will be further described below.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is a front view of an example user device in accordance with various embodiments of the present disclosure;

FIG. 2 is an angled side view of an example user device cover in accordance with various embodiments of the present disclosure;

FIG. 3 is an angled top view of an example dock device in accordance with various embodiments of the present disclosure;

FIG. 4 is an angled top view of an example dock device in accordance with various embodiments of the present disclosure;

FIG. 5 is an elevation side view of an example rotation plate in accordance with various embodiments of the present disclosure;

FIG. 6 is an elevation side, detail view of an example charging dock device in accordance with various embodiments of the present disclosure;

FIG. 7 is a detail view of an example charging dock device in accordance with various embodiments of the present disclosure;

FIG. 8 is an elevation side, detail view of an example charging dock device in accordance with various embodiments of the present disclosure;

FIG. 9 is a detail view of an example charging dock device in accordance with various embodiments of the present disclosure;

FIGS. 10A-G are detail views of an example charging dock device in accordance with various embodiments of the present disclosure; and

FIG. 11 is an example flow chart for an example method of using an example charging dock device in accordance with various embodiments of the present disclosure.

### DETAILED DESCRIPTION OF SOME EXAMPLE EMBODIMENTS

Various embodiments of the present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily may refer to the same embodiment).

### Overview

According to various embodiments of this disclosure, there is provided a charging dock device that can adjust to accommodate user devices of various sizes, shapes, and orientations. In some embodiments, the charging dock device can also adjust to accommodate user devices when they are and are not at least partially encased in a sleeve or similar protector.

In some embodiments, the charging dock device may include a base and a housing configured to receive the user device. In some embodiments, various circuitry may be housed within the base and/or the housing and configured to restore power to a user device once the user device is placed on or within the housing.

In some embodiments, to facilitate the aforementioned adjustment, the charging dock device may include one or more rotation plates disposed within the housing. In some embodiments, the rotation plates may be configured to adjust their orientation within the housing such that the housing can accommodate user devices of varying sizes, shapes, and orientations, as well as user devices at least partially encased in a sleeve or other protector.

In some embodiments, the rotation plates may rotate within the housing between a first, upright position and a second, downward position. In some embodiments, when the rotation plates are in the first or “open,” upright position, the housing may be configured to receive a user device with a smaller profile and/or a user device not encased in a sleeve or protector. In some embodiments, when the rotation plates are in the second or “closed,” downward position, the housing may be configured to receive a user device with a larger profile and/or a user device encased in a sleeve or protector. In some embodiments, the rotation plates may be configured to toggle between these two positions and one or more intermediate positions within the housing.

### Example Charging Dock Devices

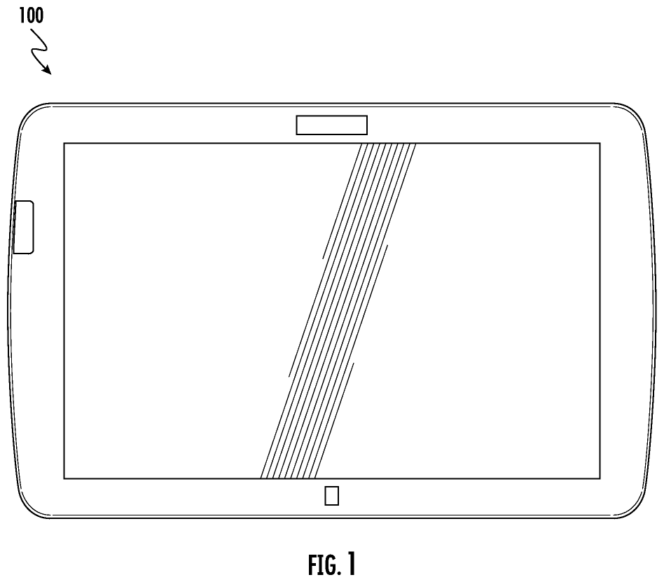

FIG. 1 shows a front view of an example user device 100, according to various embodiments. In some embodiments, the user device 100 may be a substantially rectangular electronic device with computing capabilities. In some embodiments, the user device 100 is capable of networked communication with one or more other devices. In some embodiments (and as shown in at least FIG. 1), the user device 100 may be a tablet, but it will be understood that the user device 100 may be a variety of devices, including a mobile phone, an electronic photo album, a walkie-talkie.

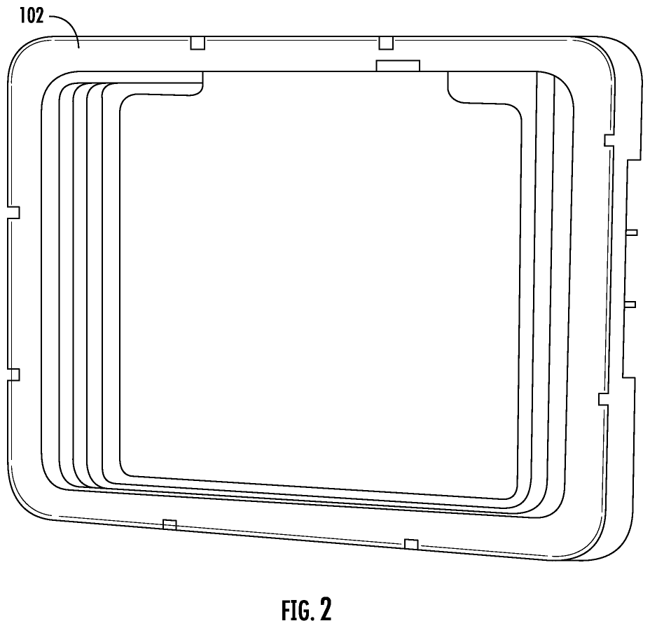

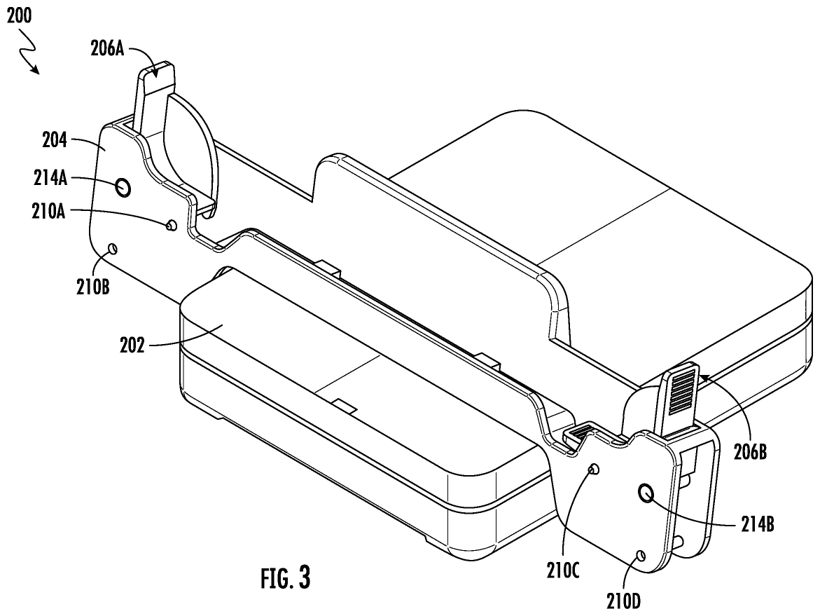

FIG. 2 shows a sleeve 102 for a user device 100, according to various embodiments. In some embodiments, the sleeve 102 may be configured to encase at least a portion of the user device 100, thereby protecting the user device 100 from damage. In some embodiments, the sleeve 102 may be ergonomically configured for a user's hand(s). In some embodiments, once the sleeve 102 is encasing at least a portion of the user device 100, the user device 100 may have a larger profile as a result of being at least partially encased. In some embodiments, the sleeve 102 may be made of rubber or similar “soft” material for being comfortably held by a user.

FIG. 3 shows an example charging dock device 200, according to various embodiments. In some embodiments, the charging dock device 200 includes a base 202. In some embodiments, the base 202 may be a substantially rectangular, block-shaped piece. In some embodiments, the base 202 may include various electronics configured to charge or otherwise interact with the user device 100. In some embodiments, the base 202 may include one or more batteries configured to provide a source of charge for the user device 100. In some embodiments, the base 202 may include one or more adapter slots for connecting to AC or DC power to supply charge to the user device 100. In some embodiments, the base 202 may be made of plastic or similar consumer-grade materials.

In some embodiments, the charging dock device 200 includes a housing 204 configured to receive one or more user devices 100. In some embodiments, the housing 204 may be a narrow, rectangular housing that defines a slot for receiving the user device 100. In some embodiments, the housing 204 may include a first end and a second end. In some embodiments, the housing 204 may be oriented perpendicular to the base 202. In some embodiments, the housing 204 may be oriented perpendicular to the base 202 such that the housing 204 overhangs the base 202 and the charging dock device 200 forms a “T” or cross-shape. In some embodiments, the housing 204 may be fixedly attached to the base 202. In some embodiments, the housing 204 may be integrated into the base 202 such that the base 202 and housing 204 are a single molded piece. In some embodiments, the housing 204 may be made of plastic or similar consumer-grade materials.

In some embodiments, the charging dock device 200 includes one or more rotation plates 206A, 206B. In some embodiments, the rotation plates 206A, 206B may be configured to be inserted into the housing 204 of the charging dock device 200. In some embodiments, the rotation plates 206A, 206B may be integrated with the housing 204 or other part of the charging dock device 200 such that the rotation plates 206A, 206B are a molded piece of the charging dock device 200. In some embodiments, the housing 204 may include one or more grooves 205A, 205B configured to respectively receive one or more rotation plates 206A, 206B. In some embodiments, the one or more grooves 205A, 205B may be disposed at the respective first and second ends of the housing 204.

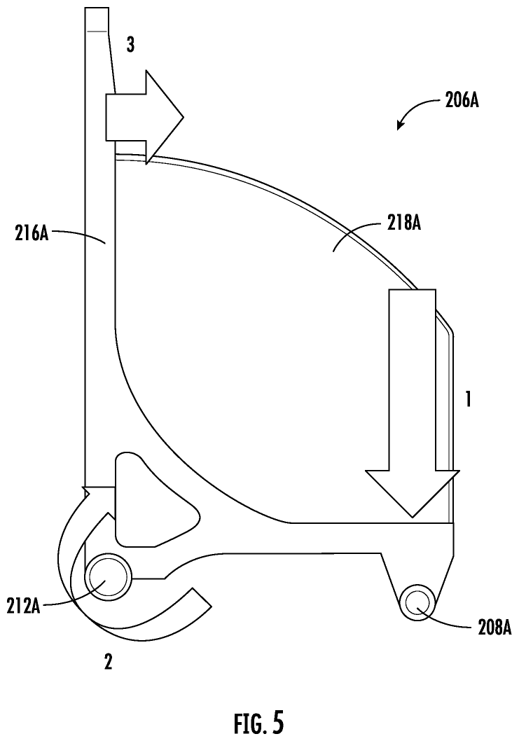

In some embodiments, and as shown in particular in FIG. 5, the rotation plate 206A may include a positioning pin 208A. In some embodiments, the positioning pin 208A may be clastic. It will be understood that the description of rotation plate 206A may apply similarly to rotation plate 206B, which in some embodiments may be symmetrical to the rotation plate 206A. In some embodiments, the positioning pin 208A may be a molded piece that is integrated with the rotation plate 206A. In some embodiments, the positioning pin 208A may be inserted into one or more corresponding positioning holes 210A-B of the housing 204. (In some embodiments, the corresponding positioning pin 208B of the rotation plate 206B may be inserted into one or more corresponding positioning holes 210C-D.)

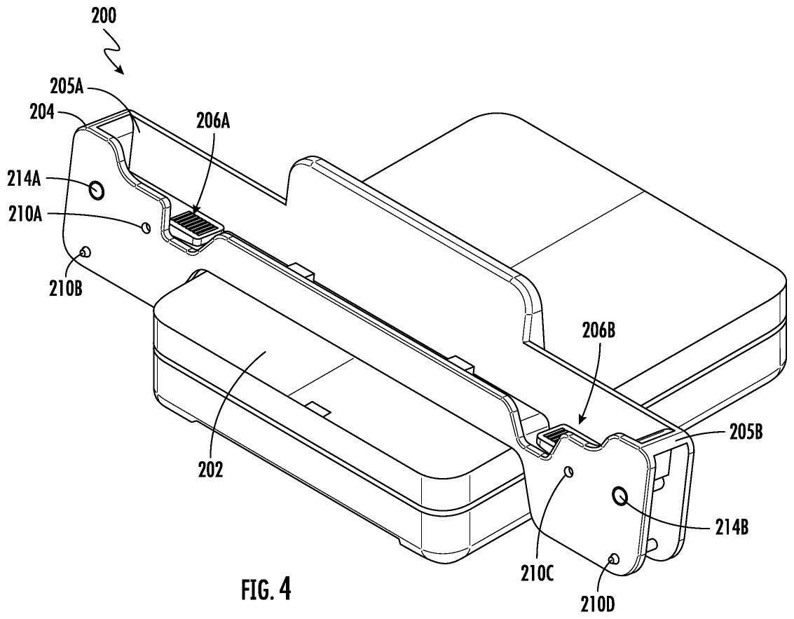

In some embodiments, still referring to FIG. 5 but also to FIGS. 3 and 4, the rotation plate 206A may include a shaft 212A, which in some embodiments may be a molded piece that is integrated with the rotation plate 206A. In some embodiments, the shaft 212A may be longer and/or broader than the positioning pin 208A. In some embodiments, the shaft 212A may be configured to be inserted into a shaft hole 214A of the housing 204. (In some embodiments, the corresponding shaft 212B may be inserted into a corresponding shaft hole 214B.)

In some embodiments, the rotation plate 206A may include a guiding rib 216A that may be substantially colinear with the shaft 212A and offset from the positioning pin 208A. In some embodiments, the guiding rib 216A may include one or more grooves for operably engaging with the grooves 205A, 205B of the housing 204.

In some embodiments, the rotation plate 206A may include a rear wall 218A, which may be a substantially flat portion of the rotation plate 206A. In some embodiments, the rear wall 218A may be curved along one or more of its edges. In some embodiments, the rear wall 218A may be configured to at least partially support the user device 100 when the user device 100 is inserted into the housing 204.

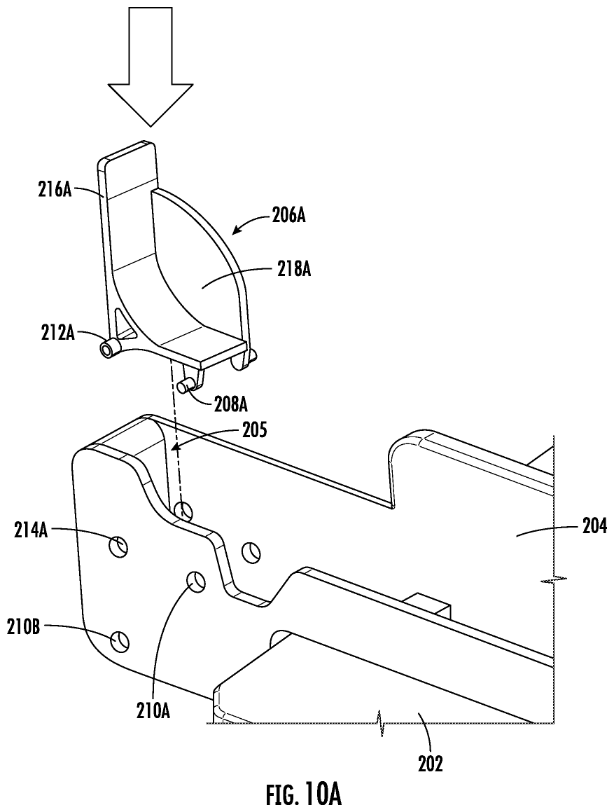

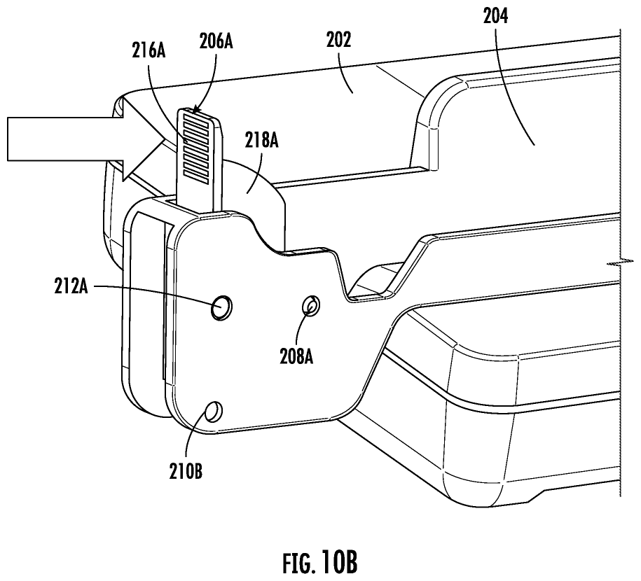

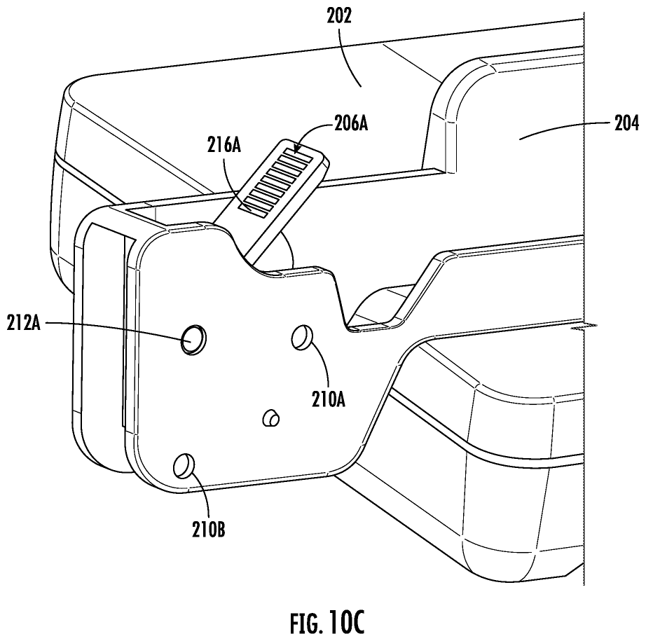

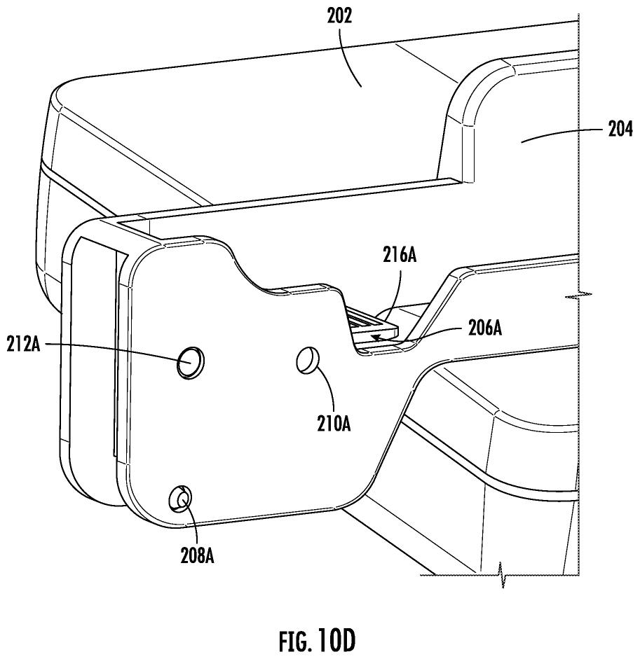

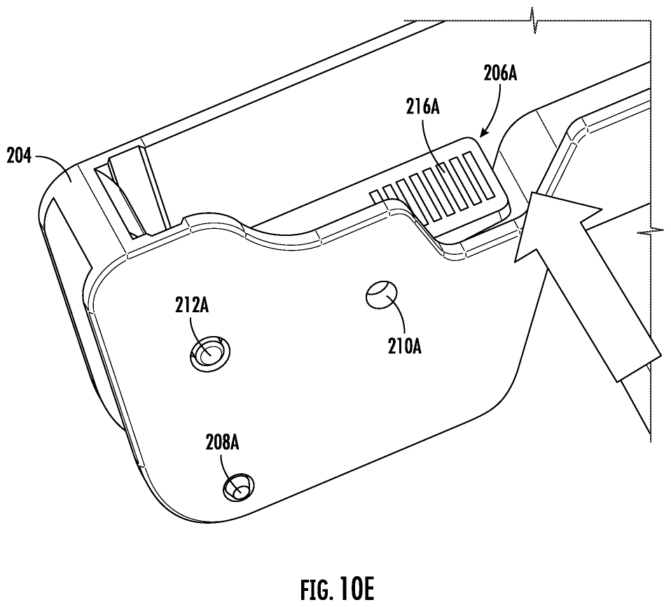

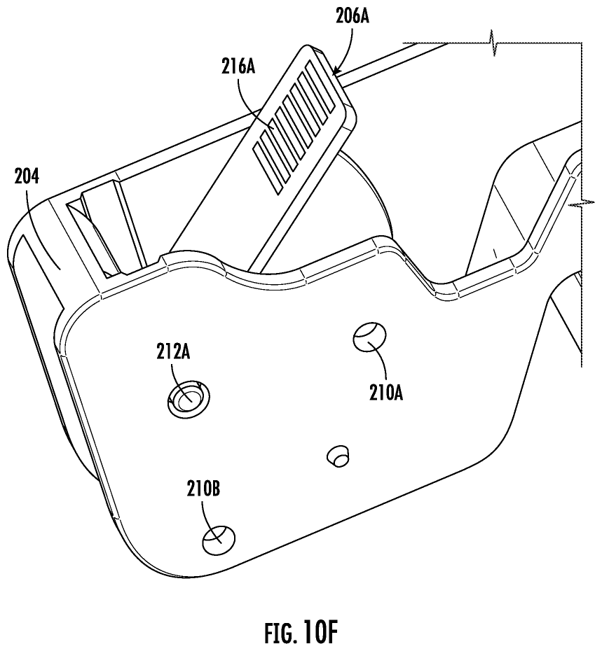

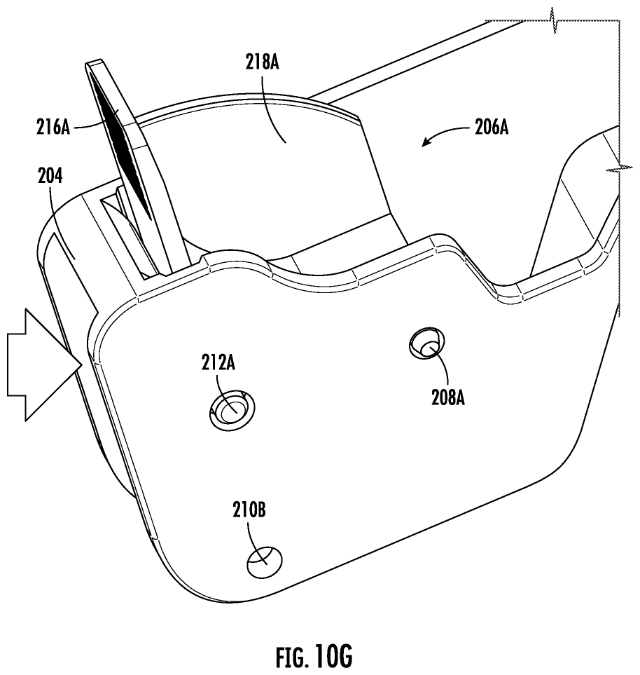

An example operation and use of the rotation plates 206A, 206B within the charging dock device 200 may be described according to various embodiments with respect to FIGS. 10A-10G.

As shown in at least FIG. 10A, in some embodiments, the rotation plate 206A may be inserted into the housing 204. In some embodiments, the rotation plate 206A may be aligned with the groove 205A. In some embodiments, the rotation plate 206B may be aligned with the groove 205B simultaneously or before or after the rotation plate 206A is aligned with the groove 205A.

As shown from at least FIGS. 10A and 10B, in some embodiments, the shaft 212A of the rotation plate 206A may be inserted into the shaft hole 214A of the housing 204. In some embodiments, the positioning pin 208A may be inserted into the positioning hole 210A. In some embodiments, the shaft 212B of the rotation plate 206B may be inserted into the shaft hole 214B of the housing 204 and its positioning pin 208B may be inserted into the positioning hole 210B. In some embodiments, the rotation plate 206A may be said to be in a first or “open” position when it is inserted into the housing 204 and is upright as shown in at least FIG. 10B.

As shown in at least FIGS. 10B-10D, in some embodiments, the rotation plate 206A may be rotated downward by applying pressure to the guiding rib 216A and moving the positioning pin 208A from the positioning hole 210A to the positioning hole 210B. It will be understood that, when the positioning pin 208A is not disposed through the positioning holes 210A and 210B, then it is shown on the outside of the housing 204 for illustrative purposes only to show the movement of the positioning pin 208A. In some embodiments, the rotation plate 206A may be said to be in a second or “closed” position when it is inserted into the housing 204 and is downward as shown in at least FIGS. 10D and 10E. It will be understood that the same rotation may be performed by the rotation plate 206B and its various components.

As shown in at least FIGS. 10E-10G, in some embodiments, the rotation plate 206A may be rotated upward by pulling on the guiding rib 216A and moving the positioning pin 208A from the positioning hole 210B to the positioning hole 210A. It will be understood that the same rotation may be performed by the rotation plate 206B and its various components.

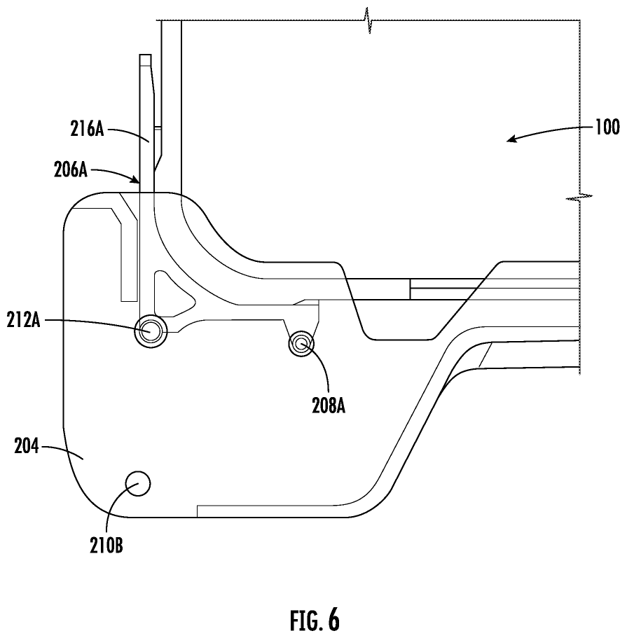

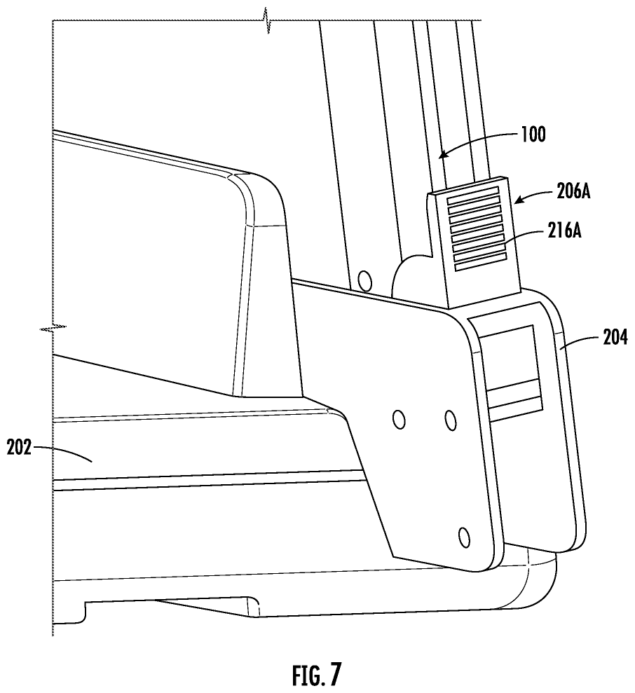

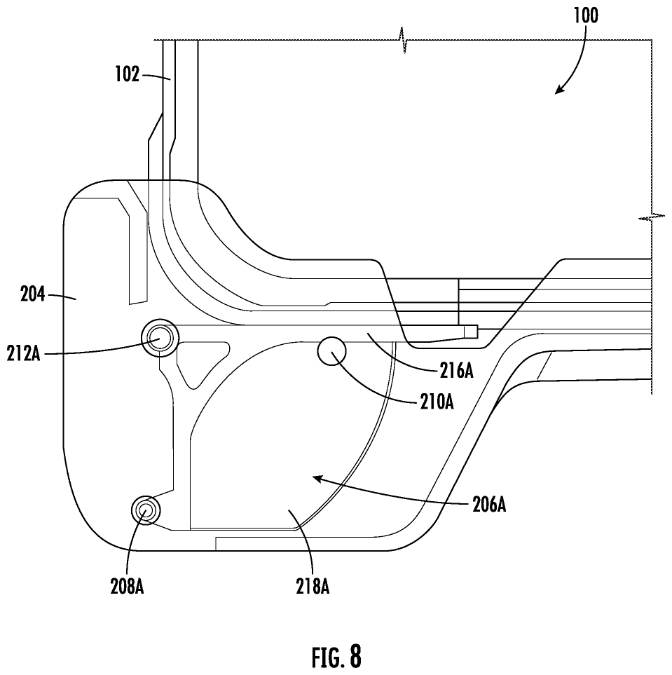

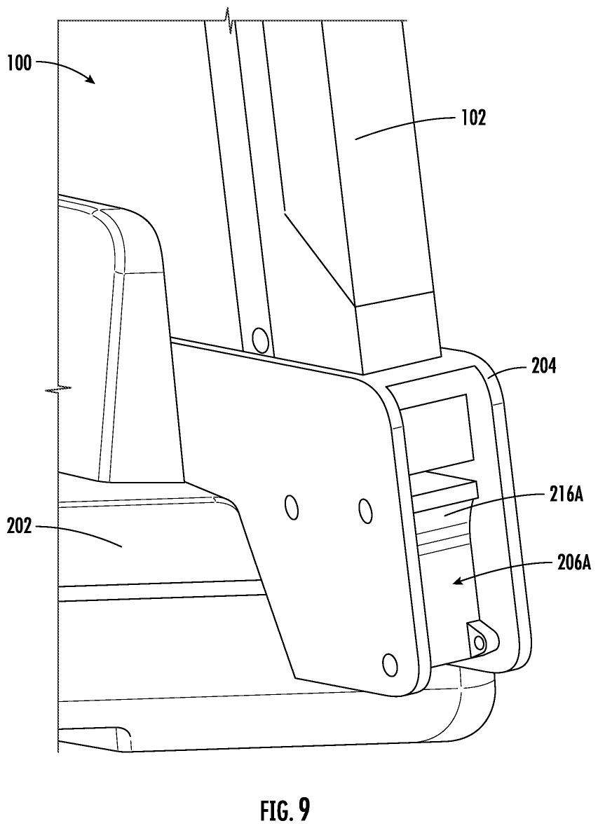

In some embodiments, when the rotation plates 206A, 206B are in the first, upright position, the housing 204 may be configured to receive a smaller user device or a user device not having a sleeve 102 (as shown in at least FIG. 6) as compared to when the rotation plates 206A, 206B are in the second, downward position, where the housing 204 may be configured to receive a larger user device or a user device having a sleeve 102 (as shown in at least FIG. 8).

### Example Methods of Use

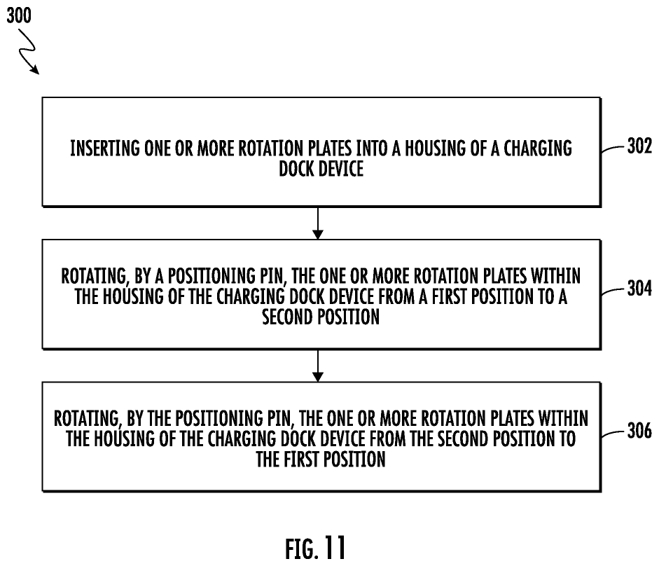

FIG. 11 shows an example flow chart depicting an example method 300 for using a charging dock device. In some embodiments, the method 300 may be implemented using the user device 100, charging dock device 200, and their respective components as previously described in this disclosure. In some embodiments, the method 300 may be implemented using other suitable devices and components as desired.

In some embodiments, the method 300 may include a step 302 of inserting one or more rotation plates into a housing of a charging dock device. In some embodiments, the method 300 may include a step 304 of rotating, by a positioning pin, the one or more rotation plates within the housing of the charging dock device from a first position to a second position. In some embodiments, the method 300 may include a step 306 of rotating, by the positioning pin, the one or more rotation plates within the housing of the charging dock device from the second position to the first position.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A charging dock device comprising:
a housing configured to receive one or more user devices,
wherein the charging dock device is configured to charge the one or more user devices when the one or more user devices are disposed on or within the housing of the charging dock device; and
one or more rotation plates disposed on or within the housing,
wherein the one or more rotation plates are configured to rotate between a first position within the housing and a second position within the housing,
wherein when the rotation plates are in the first position the housing is configured to receive a first user device of the one or more user devices, and
wherein when the rotation plates are in the second position the housing is configured to receive a second user device of the one or more user devices.

2. The charging dock device of claim 1, wherein the first user device of the one or more user devices is smaller than the second user device of the one or more user devices.

3. The charging dock device of claim 1, wherein the second user device of the one or more user devices is at least partially encased in a sleeve.

4. The charging dock device of claim 1, further comprising a base, wherein the housing is fixedly attached to the base.

5. The charging dock device of claim 1, wherein the one or more rotation plates comprise a guiding rib, wherein the housing comprises a groove, and wherein the guiding rib is configured to operably engage with the groove.

6. The charging dock device of claim 5, wherein the one or more rotation plates further comprises a shaft, wherein the housing further comprises a shaft hole, and wherein the shaft is configured to be inserted into the shaft hole.

7. The charging dock device of claim 6, wherein the one or more rotation plates further comprises a positioning pin, wherein the housing comprises one or more positioning holes, and wherein the positioning pin is configured to be inserted into and toggled between the one or more positioning holes.

8. The charging dock device of claim 1, wherein the one or more rotation plates further comprise a rear wall configured to at least partially support the one or more user devices.

9. The charging dock device of claim 1, wherein the housing comprises a first end and a second end, wherein the one or more rotation plates comprise a first rotation plate and a second rotation plate, and wherein the first rotation plate is disposed on or within the first end and the second rotation plate is disposed one or within the second end.

10. A method of using a charging dock device, the method comprising:
inserting one or more rotation plates into a housing of a charging dock device;
rotating, by a positioning pin, the one or more rotation plates within the housing of the charging dock device from a first position to a second position,
wherein when the one or more rotation plates are in the first position the housing is configured to receive a first user device; and
rotating, by the positioning pin, the one or more rotation plates within the housing of the charging dock device from the second position to the first position,
wherein when the one or more rotation plates are in the second position the housing is configured to receive a second user device.

11. The method of claim 10, further comprising inserting the first or the second user device into the housing of the charging dock device.

12. The method of claim 11, further comprising charging, by the charging dock device, the first or second user device.

13. The method of claim 10, wherein the first user device is smaller than the second user device.

14. The method of claim 10, wherein the second user device is at least partially encased in a sleeve.
